(19) United States
(12) Patent Application Publication
(10) Pub. No.: US 2016/0323404 A1
(43) Pub. Date: Nov. 3, 2016

(54) DATA COMMUNICATION METHOD AND DATA COMMUNICATION SYSTEM

(71) Applicant: HUIZHOU KIMREE TECHNOLOGY CO., LTD. SHENZHEN BRANCH, Shenzhen (CN)

(72) Inventor: Qiuming Liu, Huizhou (CN)

(21) Appl. No.: 15/208,326

(22) Filed: Jul. 12, 2016

Related U.S. Application Data
(63) Continuation of application No. PCT/CN2014/081221, filed on Jun. 30, 2014.

(51) Int. Cl. H04L 29/08; H04M 1/725; A24F 47/00

(52) U.S. Cl. CPC H04L 67/26; A24F 47/008; H04M 1/72527

(57) ABSTRACT

A data communication method and a data communication system are provided. The data communication method includes: detecting, by an electronic cigarette, usage of a liquid; generating, by the electronic cigarette, a trigger signal when the liquid is being used, where the trigger signal represents a type of the liquid; transmitting, by the electronic cigarette, the trigger signal to a user terminal bound with the electronic cigarette; generating, by the user terminal, a request signal according to the trigger signal, where the request signal requests for information related to liquids; transmitting, by the user terminal, the request signal to a service platform; and pushing, by the service platform, the information related to liquids to the user terminal according to the request signal.

### CROSS REFERENCE OF RELATED APPLICATION

This application is a continuation of International Application No. PCT/CN2014/081221, titled “DATA COMMUNICATION METHOD AND DATA COMMUNICATION SYSTEM”, and filed on Jun. 30, 2014, which is hereby incorporated by reference in its entirety.

### FIELD OF THE TECHNOLOGY

The present disclosure relates to the field of communication, particularly to a data communication method and a data communication system.

### BACKGROUND

An electronic cigarette is a new electronic product. The electronic cigarette has a look similar to that of an ordinary cigarette, and a taste similar to that of a cigarette. But the electronic cigarette is healthier and more environmentally friendly than a conventional cigarette.

However, due to poor understanding of information related to the electronic cigarette, many users of the electronic cigarette can not obtain better experiences of using the electronic cigarette based on more information related to the electronic cigarette.

In existing technology, a user's understanding of information related to the electronic cigarette is not known. Therefore, it is impossible to provide information in line with demands of the user according to a particular situation of the user.

### SUMMARY

A data communication method and a data communication system are provided in the disclosure, to acquire information of a type of liquid used by a user of an electronic cigarette, and to provide information of more types of liquids to the user of the electronic cigarette.

A data communication method is provided in the disclosure. The data communication method includes:
detecting, by an electronic cigarette, usage of a liquid;
generating, by the electronic cigarette, a trigger signal if the liquid is being used, where the trigger signal represents a type of the liquid;
transmitting, by the electronic cigarette, the trigger signal to a user terminal bound with the electronic cigarette;
generating, by the user terminal, a request signal according to the trigger signal, where the request signal requests for information related to liquids;
transmitting, by the user terminal, the request signal to a service platform; and
pushing, by the service platform, the information related to liquids to the user terminal according to the request signal.

Optionally, generating, by the user terminal, a request signal according to the trigger signal, includes:
recording, by the user terminal, the number of trigger signals representing each type of liquid, where the trigger signals are from the electronic cigarette; and
generating, by the user terminal, a request signal in the case that the number of trigger signals representing a type of liquid reaches a first preset value, where the request signal requests for information related to liquids in flavors different from that of the type of liquid.
pushing by the service platform, information related to liquids to the user equipment according to the request signal, includes:
pushing, by the service platform, the information related to liquids in different flavors to the user terminal according to the request signal.

Optionally, the generating, by the user terminal, a request signal according to the trigger signal, includes:
recording, by the user terminal, the number of trigger signals representing each type of liquid, where the trigger signals are from the electronic cigarette;
picking out, by the user terminal, a liquid in a type represented by a number, larger than a second preset value, of trigger signals; and
generating, by the user terminal, a request signal, where the request signal requests for information related to other liquids in types same or similar to the type represented by the number, larger than the second preset value, of trigger signals.
pushing by the service platform, information related to liquids to the user terminal according to the request signal, includes:
pushing, by the service platform, the information related to other liquids in types same or similar to the type represented by the number, larger than the second preset value, of trigger signals, to the user terminal according to the request signal.

Optionally, the electronic cigarette includes a passage for smoke, where a liquid detector is arranged in the passage for smoke; and
generating, by the electronic cigarette, a trigger signal, includes:
detecting, by the liquid detector, a type of the liquid in the passage for smoke; and
generating, by the liquid detector, a trigger signal corresponding to the type of the liquid.

Optionally, the electronic cigarette includes a tank for containing liquid, where a signal generator corresponding to the type of the liquid is arranged on the tank; and
generating, by the electronic cigarette, a trigger signal, includes:
generating, by the signal generator, a trigger signal corresponding to the type of the liquid.

Another data communication method is further provided in the disclosure. The data communication method includes:
detecting, by an electronic cigarette, usage of a liquid;
generating, by the electronic cigarette, a trigger signal if the liquid is being used, where the trigger signal represents a type of the liquid;
transmitting, by the electronic cigarette, the trigger signal to a user terminal bound with the electronic cigarette;
transparently transmitting, by the user terminal, the trigger signal to a service platform; and
pushing, by the service platform, information related to liquids to the user terminal according to the request signal.

Optionally, pushing by the service platform, information related to liquids to the user terminal according to the request signal includes:
recording, by the service platform, the number of trigger signals representing each type of liquid, where the trigger signals are from the electronic cigarette; and
pushing, to the user terminal by the service platform, the information related to liquids in flavors different from that of a type of liquid in the case that the number of trigger signals representing the type of liquid reaches a first preset value.

Optionally, pushing by the service platform, information related to liquids to the user terminal according to the request signal includes:
recording, by the service platform, the number of trigger signals representing each type of liquid, where the trigger signals are from the electronic cigarette;
picking out, by the service platform, a liquid in a type represented by a number, larger than a second preset value, of trigger signals; and
pushing, to the user terminal by the service platform, the information related to other liquids in types similar or same to that of the liquid represented by the number, larger than the second preset value, of trigger signals.

Optionally, the electronic cigarette includes a passage for smoke, where a liquid detector is arranged in the passage for smoke; and
generating, by the electronic cigarette, a trigger signal, includes:
detecting, by the liquid detector, a type of the liquid in the passage for smoke; and
generating, by the liquid detector, a trigger signal corresponding to the type of the liquid.

Optionally, the electronic cigarette includes a tank for containing liquid, where a signal generator corresponding to the type of the liquid is arranged on the tank; and
generating, by the electronic cigarette, a trigger signal, includes:
generating, by the signal generator, a trigger signal corresponding to the type of the liquid.

A data communication system is provided in the disclosure. The data communication system includes:
an electronic cigarette, a user terminal, and a service platform; where
the electronic cigarette is configured to detect usage of a liquid, to generate a trigger signal when the liquid is being used, and to transmit the trigger signal to a user terminal bound with the electronic cigarette, where the trigger signal represents a type of the liquid;
the user terminal is configured to generate a request signal according to the trigger signal, and to transmit the request signal to the service platform, where the request signal requests for information related to a liquid; and
the service platform is configured to push the information related to liquids to the user terminal according to the request signal.

Optionally, the user terminal is configured to record the number of trigger signals, from the electronic cigarette, representing each type of liquid, and to generate a request signal in the case that the number of trigger signals representing a type of liquid reaches a first preset value, where the request signal requests for information related to other liquids in flavors different from that of the type of liquid; and
the service platform is configured to push, according to the request signal, the information related to other liquids in flavors different from that of this type of liquid.

Optionally, the user terminal is configured to record the number of trigger signals, from the electronic cigarette, representing each type of liquid, to pick out a liquid in a type represented by a number, larger than a second preset value, of trigger signals, and to generate a request signal, where the request signal requests for information related to other liquids in flavors same or similar to that of the liquid represented by the number, larger than a second preset value, of trigger signals; and
the service platform is configured to push, according to the request signal, the information related to other liquids in flavors same or similar to that of the type of liquid represented by the number, larger than a second preset value, of trigger signals.

Optionally, the electronic cigarette includes a passage for smoke, where a liquid detector is arranged in the passage for smoke; and
the liquid detector is configured to detect a type of a liquid in the passage for smoking, to generate a trigger signal corresponding to the type of the liquid, and to transmit the trigger signal to the user terminal bound with the electronic cigarette.

Optionally, the electronic cigarette includes a tank for containing the liquid, where a signal generator corresponding to a type of the liquid is arranged on the tank; and
the signal generator is configured to generate a trigger signal corresponding to the type of the liquid, and to transmit the trigger signal to the user terminal bound with the electronic cigarette.

Another data communication system is further provided in the disclosure. The data communication system includes:
an electronic cigarette, a user terminal, and a service platform; where
the electronic cigarette is configured to detect usage of a liquid, to generate a trigger signal when the liquid is being used, and to transmit the trigger signal to the user terminal bound with the electronic cigarette, where the trigger signal represents a type of the liquid;
the user terminal is configured to transparently transmit the trigger signal to the service platform; and
the service platform is configured to push information related to liquids to the user terminal according to the request signal.

Optionally, the service platform is configured to record the number of trigger signals, from the electronic cigarette, representing each type of liquid, and to push information related to liquids in flavors different from that of a type of liquid in the case that the number of trigger signals representing the type of liquid reaches a first preset value.

Optionally, the user terminal is configured to record the number of trigger signals, from the electronic cigarette, representing each type of liquid, to pick out a liquid in a type represented by a number, larger than a second preset value, of trigger signals, and to push information related to other liquids in flavors same or similar to that of the liquid represented by the number, larger than a second preset value, of trigger signals.

Optionally, the electronic cigarette includes a passage for smoke, where a liquid detector is arranged in the passage for smoke; and
the liquid detector is configured to detect a type of a liquid in the passage for smoking, to generate a trigger signal corresponding to the type of the liquid, and to transmit the trigger signal to the user terminal bound with the electronic cigarette.

Optionally, the electronic cigarette includes a tank for containing liquid, where a signal generator corresponding to a type of the liquid is arranged on the tank; and
the signal generator is configured to generate a trigger signal corresponding to the type of the liquid, and to transmit the trigger signal to the user terminal bound with the electronic cigarette.

According to the technical solutions above, advantages of the disclosure include:

In the disclosure, usage of a liquid is detected by an electronic cigarette; when the liquid is being used, the electronic cigarette generates a trigger signal and transmits the trigger signal to a user terminal bound with the electronic cigarette, where the trigger signal represents a type of the liquid. Thus, the user terminal may analyze the trigger signals to learn the usage, by a user of the electronic cigarette, of the liquid, and then can acquire, from a service platform, information of liquids as desired by the user. Alternatively, the user terminal may transmit the trigger signal to a service platform. Thus, the service platform may analyze the trigger signals to learn the usage, by a user of the electronic cigarette, of the liquid, and then can push information of liquids as desired by the user. Thereby better products and services may be provided to various users of the electronic cigarette.

### BRIEF DESCRIPTION OF THE DRAWINGS

To better describe the technical solutions in embodiments of the disclosure, drawings for description of the embodiments are briefly described below. Apparently, the drawings described below are merely a few embodiments of the disclosure. For those skilled in the art, other drawings may be obtained without paying any creative work according to these drawings.

FIG. 1 is a flow chart of an embodiment of a data communication method provided in the disclosure;

FIG. 2 is a flow chart of another embodiment of a data communication method provided in the disclosure;

FIG. 3 is a flow chart of another embodiment of a data communication method provided in the disclosure;

FIG. 4 is a flow chart of another embodiment of a data communication method provided in the disclosure;

FIG. 5 is a flow chart of another embodiment of a data communication method provided in the disclosure;

FIG. 6 is a flow chart of another embodiment of a data communication method provided in the disclosure;

FIG. 7 is a structural diagram of two embodiments of a data communication system provided in the disclosure; and

FIG. 8 is a diagram of a data communication framework provided in the disclosure.

### DETAILED DESCRIPTION OF THE EMBODIMENTS

A data communication method and a data communication system are provided in embodiments of the disclosure, and thereby various users of electronic cigarettes can be classified, so that better products and services can be provided to the users of electronic cigarettes.

Next, technical solutions in the embodiments of the disclosure are clearly and fully described in combination with the drawings in the embodiments of the disclosure. Apparently, the described embodiments are merely a few instead of all embodiments of the disclosure. Based on the embodiments in the disclosure, any other embodiment obtained by those skilled in the art without creative work falls within a scope of the disclosure.

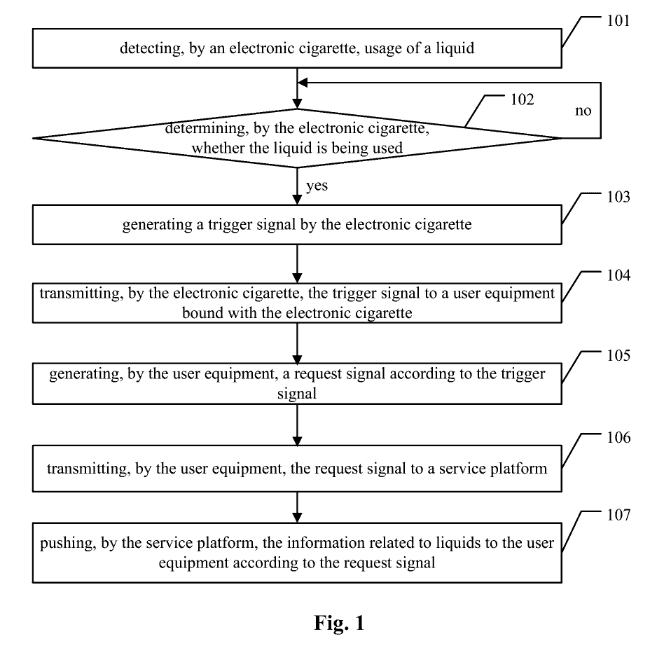

As shown in FIG. 1, an embodiment of a data communication method provided in the disclosure includes steps 101 to 107.

Step 101 includes: detecting, by an electronic cigarette, usage of a liquid.

The liquid is being used when a user smokes the electronic cigarette, i.e, when the user is smoking the electronic cigarette, it can be regarded as that the liquid is being used. Therefore, to detect the usage of the liquid, the electronic cigarette may detect whether the user is smoking the electronic cigarette. Certainly, in practice, the electronic cigarette may also detect the usage of the liquid by other methods.

Step 102 includes: determining, by the electronic cigarette, whether the liquid is being used; performing step 103 in the case that the liquid is being used, or repeating step 102 in the case that the liquid is not being used.

In the embodiment, after detecting the usage of the liquid, the electronic cigarette can determine whether the liquid is being used. If the liquid is being used, step 103 is performed. If the liquid is not being used, the determination is repeated.

It should be noted that, there may be a variety of ways in which the electronic cigarette determines whether the liquid is being used by detecting whether the user is smoking the electronic cigarette. For example, it may be determined according to a working status of an atomizer assembly in the electronic cigarette. When the atomizer assembly is working, it can be determined that the user is smoking the electronic cigarette. Alternatively, it may be determined according to a working status of a sensor in the electronic cigarette. When the sensor is working, it can be determined that the user is smoking the electronic cigarette. Alternatively, it may be determined according to a speed of battery power consumption in the electronic cigarette. When the speed of battery power consumption is higher that a threshold, it can be determined that the user is smoking the electronic cigarette.

In the embodiment, the sensor may be an airflow sensor switch, a button switch, or a switch in another type, which is not limited here. Where, the button switch may be a tact switch, a sensor switch, or a switch in another type, which is not limited here.

It can be understood that, in practice, there may be many other ways in which the electronic cigarette determines whether the liquid is being used by detecting whether the user is smoking the electronic cigarette, which is not limited here.

Step 103 includes: generating a trigger signal by the electronic cigarette.

In case of detecting that the liquid is being used, i.e, in case of detecting that the user is smoking the electronic cigarette, the electronic cigarette generates a trigger signal, where the trigger signal represents a type of a liquid.

There may be a variety of ways in which the electronic cigarette generates a trigger signal. For example, a passage for smoke, which is arranged in the electronic cigarette for transferring atomized liquid, transfers the atomized liquid to a mouthpiece end of the electronic cigarette, to make the user smoke. A liquid detector is arranged in the passage for smoke in the electronic cigarette, where the liquid detector can detect a type of the liquid.

In the case that it is detected that the liquid is being used, the liquid detector is switched on, and detects the type of the liquid, to generate a trigger signal in one-to-one correspondence with the type of the liquid. To avoid misuse, the liquid detector in the passage for smoke is arranged close to the mouthpiece end, to ensure the trigger signal is generated only when the user is smoking the atomized liquid.

Alternatively, a signal generator in one-to-one correspondence with the type of the liquid contained in a tank may be arranged on the tank of the electronic cigarette for containing liquid. In practice, there are a variety of structures for the tank of the electronic cigarette for containing liquid. For example, the tank may be a lecythus arranged at an end of an atomizer of the electronic cigarette for atomizing the liquid. Or, the tank may be a linear arranged in the atomizer (such as a liquid storage medium surrounding an electric heating wire of the atomizer), which is not limited here.

In the case that it is detected that the liquid is being used, the signal generator is switched on, and generates a trigger signal in one-to-one correspondence with the type of the liquid contained in the tank. Or, the signal generator may be triggered to generate a trigger signal and transmit the trigger signal to a user terminal in the case that the tank is installed in the electronic cigarette for the first time.

Certainly, in practice, when the liquid is being used, the electronic cigarette may generate the trigger signal, representing the type of the liquid, in another way, which is not limited here.

Step 104 includes: transmitting, by the electronic cigarette, the trigger signal to a user terminal bound with the electronic cigarette.

After generating the trigger signal, the electronic cigarette may transmit the trigger signal to a user terminal bound with the electronic cigarette in advance.

In the embodiment, the user terminal may be a cell phone, a personal computer, a tablet, or a terminal in another type, which is not limited here.

Step 105 includes: generating, by the user terminal, a request signal according to the trigger signal.

After receiving the trigger signal from the electronic cigarette, the user terminal performs analysis on the trigger signal, to generate a request signal according to a result of the analysis, where the request signal requests for information related to the liquid. Where, the information related to the liquid may include a variety of information. For example, the information related to the liquid may include a price of the liquid, a point of sale or a sales website, a function, population to whom applicable, appropriate time when used, or other liquids which can be used in combination with this type of liquid. The relevant information may also include other liquids with prices, flavors, or functions same/similar to that of the liquid.

There are a variety of methods to perform analysis on the trigger signal. For example, the user terminal calculates the number of the types of the liquids, a frequency of use and/or time of use, total used times of various types of liquids, a proportion between used times of each type of liquid and the total used times, a trend of changing of usage of the liquid over time, and so on, which are included in the trigger signal. And then the user terminal generates the request signal according to the result of the analysis, where the request signal requests for information related to one or several types of liquids which are top in a frequency of use, time of use, used times, or used proportion.

Alternatively, the user terminal may do not perform analysis on the trigger signal. In stead, the user terminal generates a request signal directly according to all the types of liquids included in the trigger signal, and the request signal requests for information related to all the types of liquids included in the trigger signal.

Certainly, the above description is merely illustrative, which is not limited to the examples.

Step 106 includes: transmitting, by the user terminal, the request signal to a service platform.

After generating the request signal, the user terminal transmits the request signal to the service platform.

In particular, the user terminal may transmit the request signal to the service platform via a mobile communication network, a WIFI network, or a network in another type, which is not limited here.

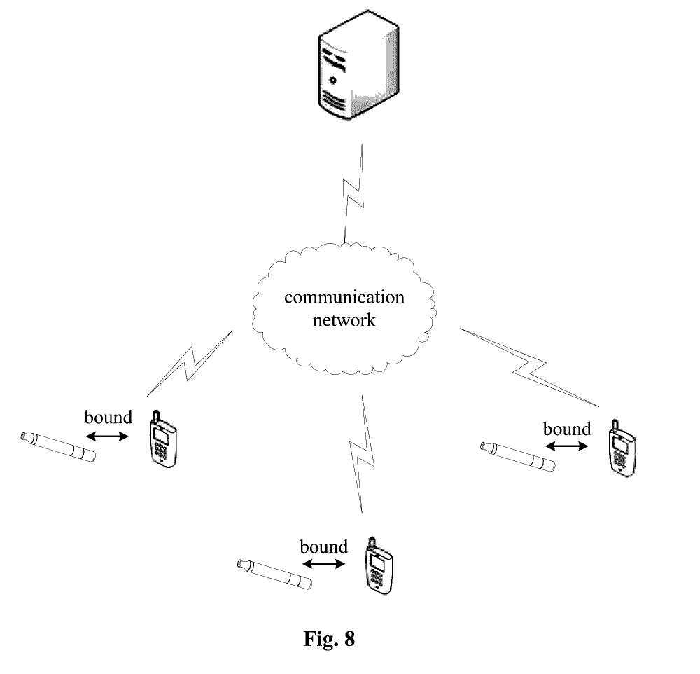

A data communication framework in the embodiment is shown as FIG. 8. The electronic cigarette is bound with the user terminal connected, via a communication network with the service platform, and the service platform may provide services to multiple users and user terminals.

Step 107 includes: pushing, by the service platform, the information related to liquids to the user terminal according to the request signal.

After receiving the request signal from the user terminal, the service platform pushes the information related to liquids, for which the request signal requests, to the user terminal according to content of the information for which the request signal requests.

It should be noted that, in the embodiment, if an APP corresponding to the electronic cigarette is installed on the user terminal, then the service platform may push the information to the APP, and the information is represented to the user by the APP. If the APP is not installed on the user terminal, then the service platform may push the information to the other programs (such as a browser) already on the user terminal, and the information is represented by the programs, which are not limited here.

In the disclosure, usage of a liquid is detected by an electronic cigarette; when the liquid is being used, the electronic cigarette generates a trigger signal and transmits the trigger signal to a user terminal bound with the electronic cigarette, where the trigger signal represents a type of the liquid. Thus, the user terminal may analyze the trigger signals to learn the usage, by a user of the electronic cigarette, of the liquid, and then can acquire, from a service platform, information of liquids as desired by the user, so that better products and services may be provided to various users of the electronic cigarette. In addition, the user terminal initially transmits a request signal to the service platform to acquire information related to liquids, so that the service platform can push data timely and efficiently.

Preferably, before transmitting, by the user terminal, the request signal to a service platform in step 106, the user terminal further issues a reminder notification, to inquire whether the user accepts the information related to the liquid. In particular, the user terminal may open a pop-up window on a display webpage, where the query is raised via text in the pop-up window, and provide two options, which are agree and disagree, for the user's choice. Certainly, in practice, the reminder notification may also be issued in other ways, which are not limited here.

In the case that the user terminal receives a choice of the option agree, the user terminal transmits the request signal to the service platform, and receives from the service platform the information related to liquids.

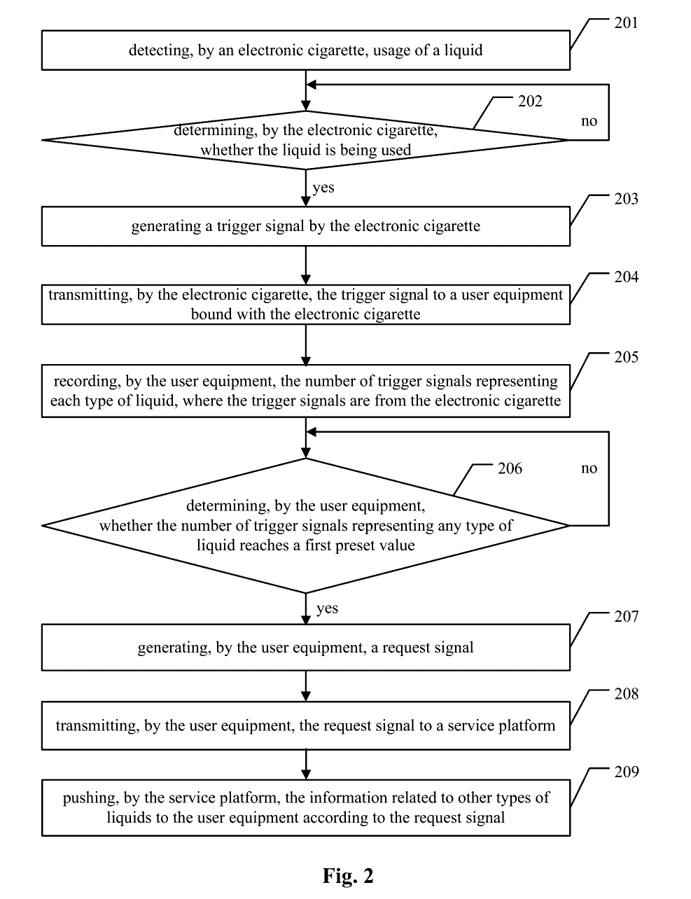

In the above embodiment, the user terminal generates the request signal according to the trigger signal. In practice, there are a variety of ways in which the user terminal can generate the request signal according to the trigger signal. Next, the data communication method in this embodiment is described. As shown in FIG. 2, an embodiment of the data communication method in the disclosure includes steps 201 to 209.

Step 201 includes: detecting, by an electronic cigarette, usage of a liquid.

For detailed description, one can refer to the step 101 in the embodiment as shown in FIG. 1.

Step 202 includes: determining, by the electronic cigarette, whether the liquid is being used, and performing step 203 in the case that the liquid is being used, or repeating step 202 in the case that the liquid is not being used.

For detailed description, one can refer to the step 102 in the embodiment as shown in FIG. 1.

Step 203 includes: generating a trigger signal by the electronic cigarette.

For detailed description, one can refer to the step 103 in the embodiment as shown in FIG. 1.

Step 204 includes: transmitting, by the electronic cigarette, the trigger signal to a user terminal bound with the electronic cigarette.

For detailed description, one can refer to the step 104 in the embodiment as shown in FIG. 1.

Step 205 includes: recording, by the user terminal, the number of trigger signals representing each type of liquid, where the trigger signals are from the electronic cigarette.

The user terminal records the types of liquids represented by the trigger signals, and performs statistics on the number of trigger signals representing a type of liquid.

Every time receiving a trigger signal, the user terminal updates the recorded types of liquid included by the various trigger signals and the number of trigger signals representing a type of liquid.

Step 206 includes: determining, by the user terminal, whether the number of trigger signals representing any type of liquid reaches a first preset value, and performing step 207 in the case that the number of trigger signals reaches the first preset value, or repeating step 206 in the case that the number of trigger signals does not reach the first preset signal.

After updating the recorded types of liquid included by the various trigger signals and the number of trigger signals representing a type of liquid, the user terminal determines whether the number of trigger signals reaches the first preset value. In the case that the number of trigger signals reaches the first preset value, it is indicated that the user of the electronic cigarette uses this type of liquid over a long term. Where, the first preset value may be set as default by the user terminal, or be set by input from the user, and the way is not limited here.

Step 207 includes: generating, by the user terminal, a request signal.

In the case that the number of trigger signals reaches the first preset value, it is indicated that the user uses this type of liquid over a long term. Then, the user terminal may promote to the user liquids in flavors different from that of this type of liquid.

Therefore, the user terminal generates a request signal, where the request signal requests for information related to other liquids, where other liquids indicate liquids in flavors different from that of the liquid represented by the number of trigger signals reaching the first preset value.

For detailed description of the information related to liquids, one can refer to the step 105 in the embodiment as shown in FIG. 1.

Step 208 includes: transmitting, by the user terminal, the request signal to a service platform.

For detailed description, one can refer to the step 106 in the embodiment as shown in FIG. 1.

Step 209 includes: pushing, by the service platform, the information related to other types of liquids to the user terminal according to the request signal.

After receiving the request signal from the user terminal, the service platform pushes the information related to other liquids, for which the request signal requests, to the user terminal.

For other detailed description, one can refer to the step 107 in the embodiment as shown in FIG. 1.

In the embodiment, the user terminal records the number of trigger signals, from the electronic cigarette, representing each type of liquid, and determines the user uses a type of liquid over a long term in the case that the number of trigger signals reaches a first preset value. Thus, the user terminal can provide to the user information of liquids other than the liquid used over the long term by the user. Thereby other types of liquids can be promoted to the user, more liquid options can be provided to the user, and a user experience is improved.

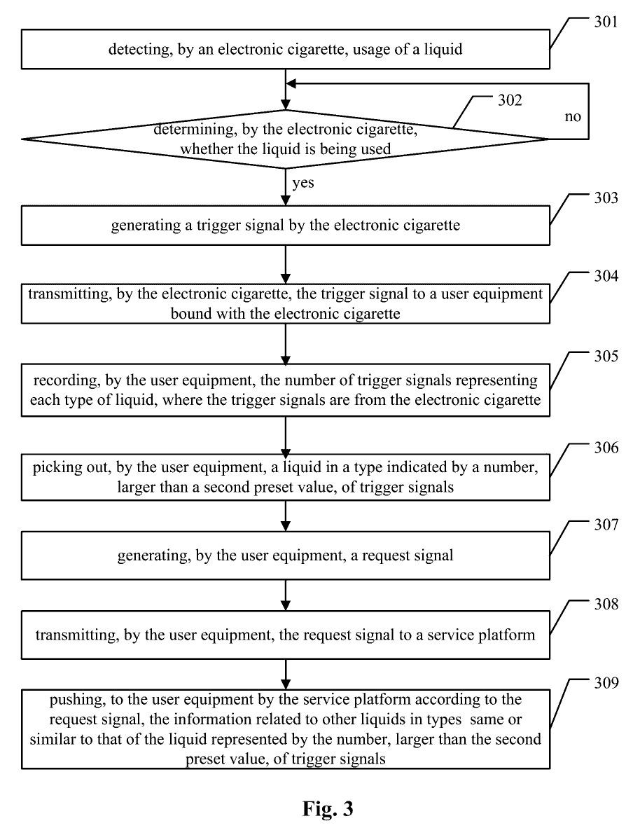

A method for generating a request signal by the user terminal according to the trigger signal is described in the above embodiment. Next, another method for generating a request signal by the user terminal according to the trigger signal is described. As shown in FIG. 3, an embodiment of the data communication method in the disclosure includes steps 301 to 309.

Step 301 includes: detecting, by an electronic cigarette, usage of a liquid.

For detailed description, one can refer to the step 101 in the embodiment as shown in FIG. 1.

Step 302 includes: determining, by the electronic cigarette, whether the liquid is being used, and performing step 303 in the case that the liquid is being used, or repeating step 302 in the case that the liquid is not being used.

For detailed description, one can refer to the step 102 in the embodiment as shown in FIG. 1.

Step 303 includes: generating, by the electronic cigarette, a trigger signal.

For detailed description, one can refer to the step 103 in the embodiment as shown in FIG. 1.

Step 304 includes: transmitting, by the electronic cigarette, the trigger signal to a user terminal bound with the electronic cigarette.

For detailed description, one can refer to the step 104 in the embodiment as shown in FIG. 1.

Step 305 includes: recording, by the user terminal, the number of trigger signals representing each type of liquid, where the trigger signals are from the electronic cigarette.

For detailed description, one can refer to the step 205 in the embodiment as shown in FIG. 2.

Step 306 includes: picking out, by the user terminal, a liquid in a type represented by a number, larger than a second preset value, of trigger signals.

After updating the recorded types of liquid included by the various trigger signals and the number of trigger signals representing a type of liquid, the user terminal picks out the liquid in the type represented by the number, larger than the second preset value, of trigger signals. Thus, the type of liquid represented by the number, larger than the second preset value, of trigger signals indicates a liquid often used or preferred by the user. Where, the second preset value may be set as default by the user terminal, or be set by input from the user, and the way is not limited here.

Step 307 includes: generating, by the user terminal, a request signal.

After determining the liquid often used or preferred by the user, the user terminal may promote to the user other liquids same or similar to this type of liquid, such as another liquid at a price, in a flavor, or having a function same or similar to that of this type of liquid, which is not limited here.

Therefore, the user terminal generates a request signal, where the request signal requests for information related to other liquids, where other liquids indicates other liquids at prices, in flavors, or having functions same or similar to that of the type of liquid represented by the number, larger than the second preset value, of trigger signals.

Step 308 includes: transmitting, by the user terminal, the request signal to a service platform.

For detailed description, one can refer to the step 106 in the embodiment as shown in FIG. 1.

Step 309 includes: pushing, to the user terminal by the service platform according to the request signal, the information related to other liquids in types same or similar to that of the type of liquid represented by the number, larger than the second preset value, of trigger signals.

After receiving the request signal from the user terminal, the service platform pushes the information related to other liquids in types same or similar to that of the liquid represented by the number, larger than the second preset value, of trigger signals.

In the embodiment, the user terminal records the number of trigger signals, from the electronic cigarette, representing each type of liquid, and picks out a liquid in a type represented by a number, larger than a second preset value, of trigger signals. Thus, the user terminal can learn the liquid often used or preferred by the user, and acquire, from a service platform, information of other liquids in types similar or same to that of the liquid often used or preferred by the user. Thereby more liquid options are provided to the user, and a user experience is improved.

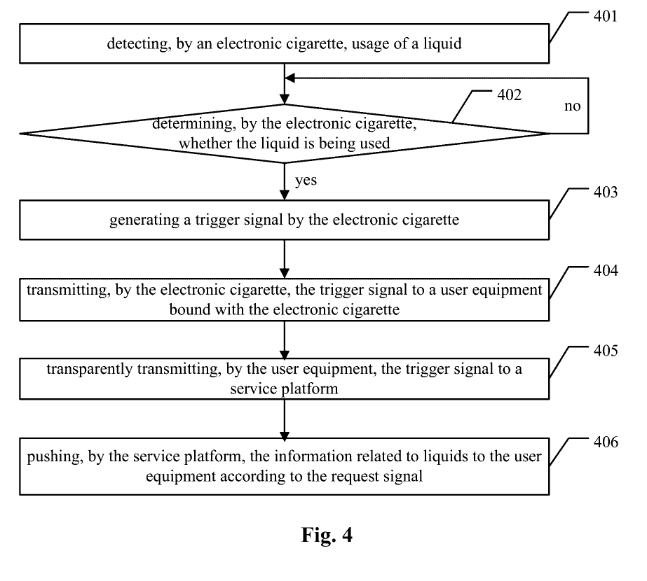

A method for generating a request signal by the user terminal according to the trigger signal is described in the above embodiment. Next, another method for generating a request signal by the user terminal according to the trigger signal is described. As shown in FIG. 4, an embodiment of the data communication method in the disclosure includes steps 401 to 406.

Step 401 includes: detecting, by an electronic cigarette, usage of a liquid.

For detailed description, one can refer to the step 101 in the embodiment as shown in FIG. 1.

Step 402 includes: determining, by the electronic cigarette, whether the liquid is being used, and performing step 403 in the case that the liquid is being used, or repeating step 402 in the case that the liquid is not being used.

For detailed description, one can refer to the step 102 in the embodiment as shown in FIG. 1.

Step 403 includes: generating, by the electronic cigarette, a trigger signal.

For detailed description, one can refer to the step 103 in the embodiment as shown in FIG. 1.

Step 404 includes: transmitting, by the electronic cigarette, the trigger signal to a user terminal bound with the electronic cigarette.

For detailed description, one can refer to the step 104 in the embodiment as shown in FIG. 1.

Step 405 includes: transparently transmitting, by the user terminal, the trigger signal to a service platform.

After receiving the trigger signal transmitted by the electronic cigarette, the user terminal may directly and transparently transmit the trigger signal to the service platform.

In particular, the user terminal may transmit the trigger signal to the service platform via a mobile communication network, a WIFI network, or a communication network in another type.

In practice, the user terminal may convert the trigger signal into data in an XML type or JSon type, and then transparently transmit the data to the service platform, which is not specifically limited here.

A data communication framework in this embodiment is shown in FIG. 4. An electronic cigarette is bound with a user terminal connecting to a service platform via a communication network, where the service platform can provide services to multiple electronic cigarettes and user equipments.

Step 406 includes: pushing, by the service platform, information related to liquids to the user terminal according to the request signal.

After receiving the trigger signal from the electronic cigarette, the service platform performs statistics and analysis on trigger signals, to determine information related to liquids to be pushed to the user terminal according to results of the statistics and analysis. Where, the information related to liquids pushed to the user terminal by the service platform may include a variety of information. For example, the information related to the liquid may include a price of the liquid, a point of sale or a sales website, a function, population to whom applicable, appropriate time when used, or other liquids which can be used in combination with this type of liquid. The relevant information may also include other liquids with prices, flavors, or functions same/similar to that of the liquid.

There are a variety of methods for performing statistics and analysis on the trigger signal by the service platform. For example, the service platform calculates the number of the types of liquid, a frequency of use and/or time of use, total used times of various types of liquid, a proportion between used times of each type of liquid and the total used times, a trend of changing of usage of the liquid over time, and so on, which are included in the trigger signal. And then the service platform pushes information related to one or several types of liquid which are top in a frequency of use, time of use, used times, or used proportion.

Or, the service platform may also not perform statistics or analysis on the trigger signal. In stead, the service platform directly pushes to the user terminal the information related to all the types of liquids included in the trigger signal.

Certainly, the above description is merely illustrative, which is not limited to the examples.

In the embodiment, usage of a liquid is detected by an electronic cigarette; when the liquid is being used, the electronic cigarette generates a trigger signal and transmits the trigger signal to a user terminal bound with the electronic cigarette, where the trigger signal represents a type of the liquid. Thus, the service platform can perform statistics and analysis on the trigger signals to learn the usage, by a user of the electronic cigarette, of the liquid, and then can push information of liquids as desired by the user, so that better products and services may be provided to various users of the electronic cigarette. In addition, if a lot of data is uploaded by the electronic cigarette, then a lot of data are to be processed by the user terminal in the embodiment as shown in FIG. 1. This will cause a low speed of the user terminal and a poor user experience. While if this embodiment is adopted, the problem of the low speed of the user terminal can be avoided. Further, the trigger signals received by the service platform may be analyzed in combination with other data, so as to push information to users more accurately.

Preferably, before pushing the information related to liquids to the user terminal, the service platform first transmits a reminder notification to the user terminal, to inquire whether the user accepts the information related to the liquids. In particular, the user terminal may open a pop-up window on a display webpage, where the query is raised via text in the pop-up window, and provide two options, which are agree and disagree, for the user's choice. Certainly, in practice, the reminder notification may also be issued in other ways, which are not limited here.

In the case that a choice of the option agree is received, the user terminal transmits the request signal to the service platform. When receiving the request signal, the service platform pushes the information related to the liquids to the user terminal.

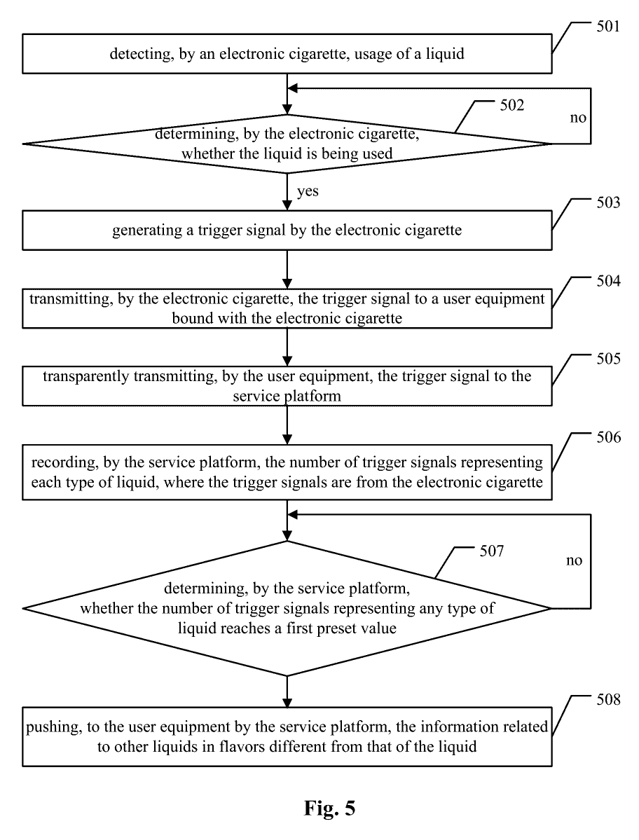

In practice, there are a variety of ways in which the service platform pushes information related to liquids to the user terminal. As shown in FIG. 5, an embodiment of the data communication method in the disclosure includes steps 501 to 508.

Step 501 includes: detecting, by an electronic cigarette, usage of a liquid.

For detailed description, one can refer to the step 101 in the embodiment as shown in FIG. 1.

Step 502 includes: determining, by the electronic cigarette, whether the liquid is being used, and performing step 503 in the case that the liquid is being used, or repeating step 502 in the case that the liquid is not being used.

For detailed description, one can refer to the step 102 in the embodiment as shown in FIG. 1.

Step 503 includes: generating, by the electronic cigarette, a trigger signal.

For detailed description, one can refer to the step 103 in the embodiment as shown in FIG. 1.

Step 504 includes: transmitting, by the electronic cigarette, the trigger signal to a user terminal bound with the electronic cigarette.

For detailed description, one can refer to the step 104 in the embodiment as shown in FIG. 1.

Step 505 includes: transparently transmitting, by the user terminal, the trigger signal to the service platform.

For detailed description, one can refer to the step 405 in the embodiment as shown in FIG. 4.

Step 506 includes: recording, by the service platform, the number of trigger signals representing each type of liquid, where the trigger signals are from the electronic cigarette.

The service platform records the types of liquids represented by the trigger signals, and performs statistics on the number of trigger signals representing a type of liquid.

Every time receiving a trigger signal, the service platform updates the recorded types of liquids included by the various trigger signals and the number of trigger signals representing a type of liquid.

Step 507 includes: determining, by the service platform, whether the number of trigger signals representing any type of liquid reaches a first preset value, and performing step 508 in the case that the number of the trigger signals reaches the first preset value, or repeating step 507 in the case that the number of the trigger signals does not reach the first preset value.

After updating the recorded types of liquids included by the various trigger signals and the number of trigger signals representing a type of liquid, the service platform determines whether the number of trigger signals reaches the first preset value. In the case that the number of trigger signals reaches the first preset value, it is indicated that the user of the electronic cigarette uses this type of liquid over a long term. Where, the first preset value may be set as default by the first service platform, or be set by input from the user, and the way is not limited here.

Step 508 includes: pushing, to the user terminal by the service platform, information related to other liquids in flavors different from that of the liquid.

When the number of trigger signals representing a type of liquid reaches the first preset value, it is indicated that the user uses this type of liquid over a long term.

Then, the service platform may promote to the user other liquids flavors different from that of this type of liquid.

For other detailed description, one can refer to the step 406 in the embodiment as shown in FIG. 4.

In the embodiment, the service platform records the number of trigger signals, from the electronic cigarette, representing each type of liquid, and determines the user uses a type of liquid over a long term in the case that the number of trigger signals reaches a first preset value. Thus, the service platform can provide to the user information of liquids other than the liquid used over the long term by the user. Thereby other types of liquid can be promoted to the user, more liquid options can be provided to the user, and a user experience is improved.

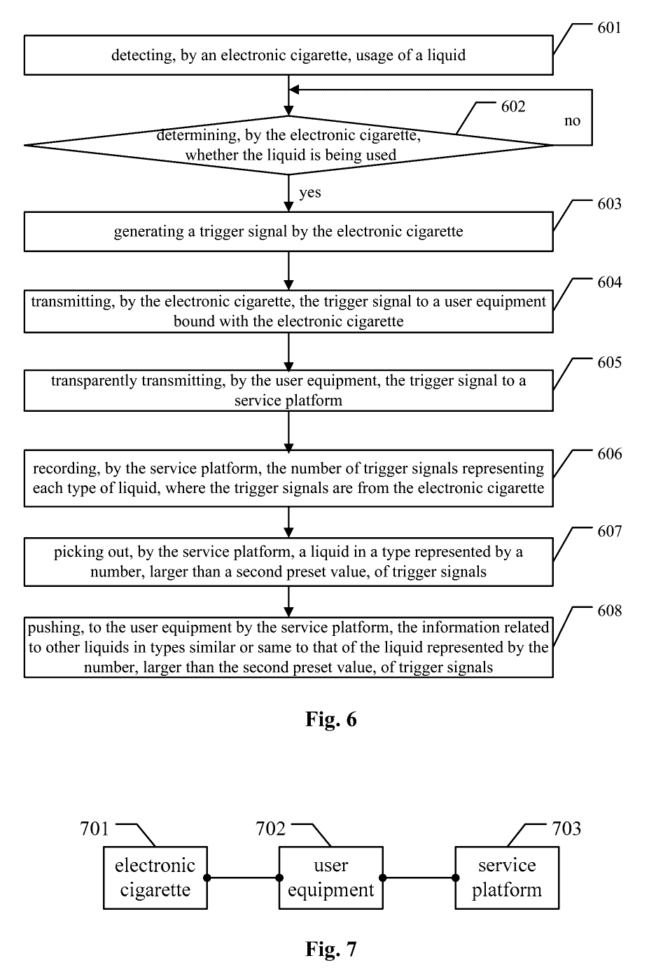

A method for pushing information related to liquids to the user terminal by the service platform according to the request signal is described in the above embodiment. Next, another method for pushing information related to liquids to the user terminal by the service platform according to the request signal is described. As shown in FIG. 6, an embodiment of the data communication method in the disclosure includes steps 601 to 608.

Step 601 includes: detecting, by an electronic cigarette, usage of a liquid.

For detailed description, one can refer to the step 101 in the embodiment as shown in FIG. 1.

Step 602 includes: determining, by the electronic cigarette, whether the liquid is being used, and performing step 603 in the case that the liquid is being used, or repeating step 602 in the case that the liquid is not being used.

For detailed description, one can refer to the step 102 in the embodiment as shown in FIG. 1.

Step 603 includes: generating, by the electronic cigarette, a trigger signal.

For detailed description, one can refer to the step 103 in the embodiment as shown in FIG. 1.

Step 604 includes: transmitting, by the electronic cigarette, the trigger signal to a user terminal bound with the electronic cigarette.

For detailed description, one can refer to the step 104 in the embodiment as shown in FIG. 1.

Step 605 includes: transparently transmitting, by the user terminal, the trigger signal to a service platform.

For detailed description, one can refer to the step 405 in the embodiment as shown in FIG. 4.

Step 606 includes: recording, by the service platform, the number of trigger signals representing each type of liquid, where the trigger signals are from the electronic cigarette.

For detailed description, one can refer to the step 506 in the embodiment as shown in FIG. 5.

Step 607 includes: picking out, by the service platform, a liquid in a type represented by a number, larger than a second preset value, of trigger signals.

After updating the recorded types of liquids included by the various trigger signals and the number of trigger signals representing a type of liquid, the service platform picks out the liquid in the type represented by the number, larger than the second preset value, of trigger signals. Thus, the liquid in the type represented by the number, larger than the second preset value, of trigger signals indicates the liquid often used or preferred by the user. Where, the second preset value may be set as default by the service platform, or may be set by input from the user, which is not limited here.

Step 608 includes: pushing, to the user terminal by the service platform, the information related to other liquids in types similar or same to that of the liquid represented by the number, larger than the second preset value, of trigger signals.

After determining the liquid often used or preferred by the user, the service platform may promote to the user other liquids same or similar to this type of liquid, where other liquids indicate other liquids at prices, in flavors, or having functions same or similar to that of this type of liquid, which is not limited here.

Other details may be referred to the description of step 406 in the embodiment as shown in FIG. 4.

In the embodiment, the service platform records the number of trigger signals, from the electronic cigarette, representing each type of liquid, and picks out the types of liquid represented by the number, larger than the second preset value, of trigger signals. Thus, the service platform can learn the liquid often used or preferred by the user, and provide to the user information of other liquids in types similar or same to the liquid often used or preferred by the user. Thereby more liquid options can be provided to the user, and a user experience is improved.

For easy understanding, a data communication method is described in detail in a particular context.

An electronic cigarette detects usage of a liquid. When a user starts smoking, the electronic cigarette determines that the liquid is being used, and generates a trigger signal and transmits the trigger signal to a user terminal bound with the electronic cigarette, where the trigger signal represents a type of the liquid.

In particular, if generating the trigger signal, the electronic cigarette first transmits a detection signal to the user terminal bound to the electronic cigarette. If the electronic cigarette receives a signal returned from the user terminal, it is indicated that the user terminal can receive the trigger signal from the electronic cigarette. Then the electronic cigarette transmits the trigger signal to the user terminal bound to the electronic cigarette.

In the embodiment, the user terminal may be a cell phone, a personal computer, a laptop, a tablet, or a terminal in another type, which is not limited here.

After receiving the trigger signal transmitted by the electronic cigarette, the user terminal transparently transmits the trigger signal to a service platform. In particular, the user terminal may transmit the trigger signal to the service platform via a mobile communication network, a WIFI network, or a communication in another type.

In practice, the user terminal may convert the trigger signal into data in an XML type or JSon type, and then transparently transmit the data to the service platform, which is not specifically limited here.

After receiving the trigger signal, the service platform stores data included in the trigger signal in to a database. In particular, a table is built in advance in the database in the service platform. A user list in which all user terminals received by the service platform are recorded, a type list of liquids used by an electronic cigarette corresponding to each user terminal, and an amount of each type of liquid used by the electronic cigarette are stored in the table. Every time receiving a trigger signal, the service platform updates the data of the user list and the type list in the table.

In addition, after updating the data in the table, the service platform determines, for each electronic cigarette, the user of the electronic cigarette uses a type of liquid in a long term when the amount of this type of liquid reaches a first preset value. The service platform pushes a reminder notification, to inquire whether the user accepts information related to a new liquid.

The user terminal transmits a request signal to a service platform if the user chooses to accept the information related to the new liquid. When receiving the request signal, the service platform pushes the information related to the new liquid to the user terminal, where the new liquid indicates a new liquid in a flavor different from that of the type of liquid used by the electronic cigarette in a long term, and the information related to the new liquid may include a price of the new liquid, a point of sale or a sales website, a function, population to whom applicable, appropriate time when used, or another liquid which can be used in combination with this type of liquid. The information related to the new liquid may also include another liquid with a price, flavor, or function same/similar to that of the new liquid. The information related to the new liquid is not limited here.

The data communication method in the embodiments of the disclosure is described above. Next, a data communication system in the embodiments of the disclosure is described. As shown in FIG. 7, the data communication system in the embodiments of the disclosure includes:
an electronic cigarette 701, a user terminal 702, and a service platform 703.

The electronic cigarette 701 is configured to detect usage of a liquid, to generate a trigger signal in the case that the liquid is being used, and to transmit the trigger signal to the user terminal 702 bound with the electronic cigarette 701, where the trigger signal represents a type of the liquid.

The user terminal 702 is configured to generate a request signal according to the trigger signal, and to transmit the request signal to the service platform 703, where the request signal requests for information related to liquids.

The service platform 703 is configured to push the information related to liquids to the user terminal 702 according to the request signal.

In the embodiment, the electronic cigarette 701 is configured to detect whether the liquid is being used by detecting whether a user is smoking the electronic cigarette. It should be noted that, there may be a variety of ways in which the electronic cigarette 701 determines whether the user is smoking the electronic cigarette. For example, it may be determined according to a working status of an atomizer assembly in the electronic cigarette 701. When the atomizer assembly is working, it can be determined that the user is smoking the electronic cigarette 701. Alternatively, it may be determined according to a working status of a sensor in the electronic cigarette 701. When the sensor is working, it can be determined that the user is smoking the electronic cigarette 701. Alternatively, it may be determined according to a speed of battery power consumption in the electronic cigarette 701. When the speed of battery power consumption is higher that a threshold, it can be determined that the user is smoking the electronic cigarette 701.

In the embodiment, the sensor may be an airflow sensor switch, a button switch, or a switch in another type, which is not limited here. Where, the button switch may be a tact switch, a sensor switch, or a switch in another type, which is not limited here. It can be understood that, in practice, there may be many other ways in which the electronic cigarette 701 determines whether the user is smoking the electronic cigarette 701, which is not limited here.

In the embodiment, there may be a variety of ways in which the electronic cigarette 701 generates a trigger signal. For example, the electronic cigarette 701 includes a passage for smoke, which is arranged in the electronic cigarette 701 for transferring atomized liquid. A liquid detector is arranged in the passage for smoke. The liquid detector is configured to detect a type of the liquid inside the passage for smoke, to generate a trigger signal corresponding to the type of the liquid, and to transmit the trigger signal to the user terminal 702 bound with the electronic cigarette 701.

Alternatively, the electronic cigarette 701 includes a tank for containing liquid. A signal generator in correspondence with the type of the liquid contained in the tank is arranged on the tank. The signal generator is configured to detect a type of the liquid inside the passage for smoke, to generate a trigger signal corresponding to the type of the liquid, and to transmit the trigger signal to the user terminal 702 bound with the electronic cigarette 701.

In the embodiment, there may be a variety of kinds of the information related to a liquid. For example, the information related to a liquid may include a price of the liquid, a point of sale or a sales website, a function, population to whom applicable, appropriate time when used, or other liquids which can be used in combination with this type of liquid. The information related to the new liquid may also include information related to another liquid with a price, flavor, or function same/similar to that of the liquid.

In the embodiment, after receiving the trigger signal from the electronic cigarette, the user terminal performs analysis on the trigger signal, to generate a request signal according to a result of the analysis, where the request signal requests for information related to liquids.

There are a variety of methods with which the user terminal may perform analysis on the trigger signal. For example, the user terminal calculates the number of the types of the liquids, a frequency of use and/or time of use of each type of liquid, total used times of various types of liquids, a proportion between used times of each type of liquid and the total used times, a trend of changing of usage of the liquid over time, and so on, which are included in the trigger signal. And then the user terminal generates the request signal according to the result of the analysis, where the request signal requests for information related to one or several types of liquids which are top in a frequency of use, time of use, used times, or used proportion.

Alternatively, the user terminal may does not perform analysis on the trigger signal. In stead, the user terminal generates a request signal directly according to all the types of liquids included in the trigger signal, and the request signal is for acquiring information related to all the types of liquids included in the trigger signal.

In the embodiment, there are a variety of methods with which the user terminal 702 may generate a request signal according to the trigger signal.

For example, the user terminal 702 records the number of trigger signals representing a type of liquid, where the trigger signal is from the electronic cigarette 701. The user terminal 702 generates a request signal in the case that the number of trigger signals reaches a first preset value. The request signal requests for information related to liquids in flavors different from that of the type of liquid.

The service platform 703 is configured to push, according to the request signal, the information related to liquids in flavors different from that of this type of liquid.

Alternatively, the user terminal is configured to record the number of trigger signals, from the electronic cigarette 701, representing each type of liquid, to pick out a liquid in a type represented by a number, larger than a second preset value, of trigger signals, and to generate a request signal, where the request signal requests for information related to other liquids in flavors same or similar to that of the liquid represented by the number, larger than a second preset value, of trigger signals.

The service platform 703 is configured to push, according to the request signal, the information related to other liquids in flavors same or similar to that of the type of liquid represented by the number, larger than a second preset value, of trigger signals.

In the disclosure, usage of a liquid is detected by an electronic cigarette; when the liquid is being used, the electronic cigarette generates a trigger signal and transmits the trigger signal to a user terminal bound with the electronic cigarette, where the trigger signal represents a type of the liquid. Thus, the user terminal may analyze the trigger signals to learn the usage, by a user of the electronic cigarette, of the liquid, and then can acquire, from a service platform, information of liquids as desired by the user, so that better products and services may be provided to various users of the electronic cigarette. In addition, the user terminal initially transmits a request signal to the service platform to acquire information related to liquids, so that the service platform can push data timely and efficiently.

A data communication system in the embodiment of the disclosure is described above. Next, another data communication system in an embodiment of the disclosure is described. As shown in FIG. 7, the data communication system in the embodiment of the disclosure includes:
an electronic cigarette 701, a user terminal 702, and a service platform 703.

The electronic cigarette 701 is configured to detect usage of a liquid, to generate a trigger signal when the liquid is being used, and to transmit the trigger signal to the user terminal 702 bound with the electronic cigarette 701, where the trigger signal represents a type of the liquid.

The user terminal 702 is configured to transparently transmit the trigger signal to the service platform 703.

The service platform 703 is configured to push information related to liquids to the user terminal 702 according to the request signal.

In the embodiment, the electronic cigarette 701 is configured to detect whether the liquid is being used by detecting whether a user is smoking the electronic cigarette. It should be noted that, there may be a variety of ways in which the electronic cigarette 701 may determine whether the user is smoking the electronic cigarette. For example, it may be determined according to a working status of an atomizer assembly in the electronic cigarette 701. When the atomizer assembly is working, it can be determined that the user is smoking the electronic cigarette 701. Alternatively, it may be determined according to a working status of a sensor in the electronic cigarette 701. When the sensor is working, it can be determined that the user is smoking the electronic cigarette 701. Alternatively, it may be determined according to a speed of battery power consumption in the electronic cigarette 701. When the speed of battery power consumption is higher that a threshold, it can be determined that the user is smoking the electronic cigarette 701.

In the embodiment, the sensor may be an airflow sensor switch, a button switch, or a switch in another type, which is not limited here. Where, the button switch may be a tact switch, a sensor switch, or a switch in another type, which is not limited here. It can be understood that, in practice, there may be many other ways in which the electronic cigarette 701 determines whether the user is smoking the electronic cigarette 701, which is not limited here.

In the embodiment, there may be a variety of ways in which the electronic cigarette 701 generates a trigger signal. For example, the electronic cigarette 701 includes a passage for smoke, which is arranged in the electronic cigarette 701 for transferring atomized liquid. A liquid detector is arranged in the passage for smoke. The liquid detector is configured to detect a type of the liquid inside the passage for smoke, to generate a trigger signal corresponding to the type of the liquid, and to transmit the trigger signal to the user terminal 702 bound with the electronic cigarette 701.

Or, the electronic cigarette 701 includes a tank for containing liquid. A signal generator in correspondence with the type of the liquid contained in the tank is arranged on the tank. The signal generator is configured to detect a type of the liquid inside the passage for smoke, to generate a trigger signal corresponding to the type of the liquid, and to transmit the trigger signal to the user terminal 702 bound with the electronic cigarette 701.

In the embodiment, there may be a variety of kinds of the information related to a liquid. For example, the information related to a liquid may include a price of the liquid, a point of sale or a sales website, a function, population to whom applicable, appropriate time when used, or other liquids which can be used in combination with this type of liquid. The information related to the new liquid may also include information related to another liquid with a price, flavor, or function same/similar to that of the liquid.

In the embodiment, after receiving the trigger signal from the electronic cigarette, the service platform 703 performs analysis on the trigger signals, to push information related to liquids to the user terminal 702 according to a result of the analysis.

There are a variety of methods with which the service platform 703 may perform analysis on the trigger signal. For example, the service platform 703 calculates the number of the types of the liquids, a frequency of use and/or time of use of each type of liquid, total used times of various types of liquids, a proportion between used times of each type of liquid and the total used times, a trend of changing of usage of the liquid over time, and so on, which are included in the trigger signal. And then the service platform 703 pushes, according to the result of the analysis, information related to one or several types of liquids which are top in a frequency of use, time of use, used times, or used proportion.

Alternatively, the service platform 703 may do not perform analysis on the trigger signal. In stead, the service platform 703 directly pushes to the user terminal 702 the information related to all the types of liquids included in the trigger signal.

In the embodiment, there are a variety of methods with which the service platform 703 may push the information related to liquids to the user terminal 702 according to the trigger signal.

For example, the service platform 703 records the number of trigger signals representing each type of liquid, where the trigger signal is from the electronic cigarette 701. The service platform 703 pushes information related to liquids in flavors different from that of a type of liquid in the case that the number of trigger signals reaches the first preset value.

Alternatively, the service platform 703 is configured to record the number of trigger signals, from the electronic cigarette 701, representing each type of liquid, to pick out a liquid in a type represented by a number, larger than a second preset value, of trigger signals, and to push to the user terminal 702 information related to other liquids in types same or similar to the liquid in the type represented by a number, larger than a second preset value, of trigger signals.

For easy understanding, the data communication system in an embodiment of the disclosure is described in a particular context.

An electronic cigarette detects usage of a liquid. When a user starts smoking, the electronic cigarette determines that the liquid is being used, and generates a trigger signal and transmits the trigger signal to a user terminal bound with the electronic cigarette, where the trigger signal represents a type of the liquid.

In particular, if generating the trigger signal, the electronic cigarette first transmits a detection signal to the user terminal bound to the electronic cigarette. If the electronic cigarette receives a signal returned from the user terminal, it is indicated that the user terminal can receive the trigger signal from the electronic cigarette. Then the electronic cigarette transmits the trigger signal to the user terminal bound to the electronic cigarette.

In the embodiment, the user terminal may be a cell phone, a personal computer, a laptop, a tablet, or a terminal in another type, which is not limited here.

After receiving the trigger signal transmitted by the electronic cigarette, the user terminal transparently transmits the trigger signal to a service platform. In particular, the user terminal may transmit the trigger signal to the service platform via a mobile communication network, a WIFI network, or a communication in another type.

In practice, the user terminal may convert the trigger signal into data in an XML type or JSon type, and then transparently transmit the data to the service platform, which is not specifically limited here.

After receiving the trigger signal, the service platform stores data included in the trigger signal in to a database. In particular, a table is built in advance in the database in the service platform. A user list in which all user terminals received by the service platform are recorded, a type list of liquids used by an electronic cigarette corresponding to each user terminal, and an amount of each type of liquid used by the electronic cigarette are stored in the table. Every time receiving a trigger signal, the service platform updates the data of the user list and the type list in the table.

In addition, after updating the data in the table, the service platform determines, for each electronic cigarette, the user of the electronic cigarette uses a type of liquid in a long term in the case that the amount of this type of liquid reaches a first preset value. The service platform pushes a reminder notification, to inquire whether the user accepts information related to a new liquid.

The user terminal transmits a request signal if the user chooses to accept the information related to a new liquid. If receiving the request signal, the service platform pushes the information related to the new liquid to the user terminal, where the new liquid indicates a new liquid in a flavor different from that of the type of liquid used by the electronic cigarette in a long term, and the information related to the new liquid may include a price of the new liquid, a point of sale or a sales website, a function, population to whom applicable, appropriate time when used, or other liquids which can be used in combination with this type of liquid. The information related to the new liquid may also include another liquid with a price, flavor, or function same/similar to that of the new liquid. The information related to the new liquid is not limited here.

The embodiments in the disclosure are described in a progressive manner. The description of each embodiment focuses on the differences from other embodiments, and description of similar parts of various embodiments can be found by mutual reference.

The foregoing description of the disclosed embodiments enables those skilled in the art to implement or use the disclosure. There are multiple modifications of the embodiments, which are obvious to those skilled in the art. The general principle defined in the specification may be implemented in other embodiments without departing from the spirit and the scope of the disclosure. Therefore, the disclosure shall not be limited to the embodiments herein, but be conformed to a broadest scope consistent with the principle and the novel features disclosed herein.

1. A data communication method, comprising:
detecting, by an electronic cigarette, usage of a liquid;
generating, by the electronic cigarette, a trigger signal if the liquid is being used, wherein the trigger signal represents a type of the liquid;
transmitting, by the electronic cigarette, the trigger signal to a user terminal bound with the electronic cigarette;
generating, by the user terminal, a request signal according to the trigger signal, wherein the request signal requests for information related to liquids;
transmitting, by the user terminal, the request signal to a service platform; and
pushing, by the service platform, the information related to liquids to the user terminal according to the request signal.

2. The data communication method according to claim 1, wherein
generating, by the user terminal, a request signal according to the trigger signal, comprises:
recording, by the user terminal, the number of trigger signals representing each type of liquid, wherein the trigger signals are from the electronic cigarette; and
generating, by the user terminal, a request signal in the case that the number of trigger signals reaches a first preset value, wherein the request signal requests for information related to liquids in flavors different from the type of liquid;
pushing, by the service platform, information related to liquids to the user terminal according to the request signal, comprises:
pushing, by the service platform, the information related to liquids in different flavors to the user terminal according to the request signal.

3. The data communication method according to claim 1, wherein
generating, by the user terminal, a request signal according to the trigger signal, comprises:
recording, by the user terminal, the number of trigger signals representing each type of liquid, wherein the trigger signals are from the electronic cigarette;
picking out, by the user terminal, a liquid in a type represented by a number, larger than a second preset value, of trigger signals; and
generating, by the user terminal, a request signal, wherein the request signal requests for information related to other liquids in types same or similar to the type represented by the number, larger than the second preset value, of trigger signals;
and pushing, by the service platform, information related to liquids to the user terminal according to the request signal, comprises:
pushing, by the service platform, the information related to other liquids in types same or similar to the type represented by the number, larger than the second preset value, of trigger signals, to the user terminal according to the request signal.

4. The data communication method according to claim 1, wherein
the electronic cigarette comprises a passage for smoke, wherein a liquid detector is arranged in the passage for smoke; and
generating, by the electronic cigarette, a trigger signal, comprises:
detecting, by the liquid detector, a type of the liquid in the passage for smoke; and
generating, by the liquid detector, a trigger signal corresponding to the type of the liquid.

5. The data communication method according to claim 1, wherein
the electronic cigarette comprises a tank for containing the liquid, wherein a signal generator corresponding to the type of the liquid is arranged on the tank; and
generating, by the electronic cigarette, a trigger signal, comprises:
generating, by the signal generator, a trigger signal corresponding to the type of the liquid.

6. A data communication method, comprising:
detecting, by an electronic cigarette, usage of a liquid;
generating, by the electronic cigarette, a trigger signal if the liquid is being used, wherein the trigger signal represents a type of the liquid;
transmitting, by the electronic cigarette, the trigger signal to a user terminal bound with the electronic cigarette;
transparently transmitting, by the user terminal, the trigger signal to a service platform; and
pushing, by the service platform, information related to liquids to the user terminal according to the request signal.

7. The data communication method according to claim 6, wherein pushing, by the service platform, information related to liquids to the user terminal according to the request signal comprises:
recording, by the service platform, the number of trigger signals representing each type of liquid, wherein the trigger signals are from the electronic cigarette; and
pushing, by the service platform, the information related to liquids in flavors different from that of a type of liquid to the user terminal in the case that the number of trigger signals representing the type of liquid reaches a first preset value.

8. The data communication method according to claim 6, wherein pushing, by the service platform, information related to liquids to the user terminal according to the request signal comprises:
recording, by the service platform, the number of trigger signals representing each type of liquid, wherein the trigger signals are from the electronic cigarette;
picking out, by the service platform, a liquid in a type represented by a number, larger than a second preset value, of trigger signals; and
pushing, to the user terminal by the service platform, the information related to other liquids in types similar or same to that of the liquid represented by the number, larger than the second preset value, of trigger signals.

9. The data communication method according to claim 6, wherein
the electronic cigarette comprises a passage for smoke, wherein a liquid detector is arranged in the passage for smoke; and
generating, by the electronic cigarette, a trigger signal, comprises:
detecting, by the liquid detector, a type of the liquid in the passage for smoke; and
generating, by the liquid detector, a trigger signal corresponding to the type of the liquid.

10. The data communication method according to claim 6, wherein
the electronic cigarette comprises a tank for containing liquid, wherein a signal generator corresponding to the type of the liquid is arranged on the tank; and
generating, by the electronic cigarette, a trigger signal, comprises:
generating, by the signal generator, a trigger signal corresponding to the type of the liquid.

11. A data communication system, comprising:
an electronic cigarette, a user terminal, and a service platform; wherein
the electronic cigarette is configured to detect usage of a liquid, to generate a trigger signal when the liquid is being used, and to transmit the trigger signal to a user terminal bound with the electronic cigarette, wherein the trigger signal represents a type of the liquid;
the user terminal is configured to generate a request signal according to the trigger signal, and to transmit the request signal to the service platform, wherein the request signal requests for information related to liquids; and
the service platform is configured to push the information related to liquids to the user terminal according to the request signal.

12. The data communication system according to claim 11, wherein
the user terminal is configured to record the number of trigger signals, from the electronic cigarette, representing each type of liquid, and to generate a request signal in the case that the number of trigger signals representing a type of liquid reaches a first preset value, wherein the request signal requests for information related to liquids in flavors different from that of the type of liquid; and
the service platform is configured to push, according to the request signal, the information related to other liquids in flavors different from that of this type of liquid.

13. The data communication system according to claim 11, wherein
the user terminal is configured to record the number of trigger signals, from the electronic cigarette, representing each type of liquid, to pick out a liquid in a type represented by a number, larger than a second preset value, of trigger signals, and to generate a request signal, wherein the request signal requests for information related to other liquids in flavors same or similar to that of the liquid represented by the number, larger than a second preset value, of trigger signals; and
the service platform is configured to push, according to the request signal, the information related to other liquids in flavors same or similar to that of the type of liquid represented by the number, larger than a second preset value, of trigger signals.

14. The data communication system according to claim 11, wherein
the electronic cigarette comprises a passage for smoke, wherein a liquid detector is arranged in the passage for smoke; and
the liquid detector is configured to detect a type of a liquid in the passage for smoking, to generate a trigger signal corresponding to the type of the liquid, and to transmit the trigger signal to the user terminal bound with the electronic cigarette.

15. The data communication system according to claim 11, wherein
the electronic cigarette comprises a tank for containing the liquid, wherein a signal generator corresponding to a type of the liquid is arranged on the tank; and
the signal generator is configured to generate a trigger signal corresponding to the type of the liquid, and to transmit the trigger signal to the user terminal bound with the electronic cigarette.
